(19) United States
(12) Patent Application Publication
(10) Pub. No.: US 2021/0181974 A1
(43) Pub. Date: Jun. 17, 2021

(54) SYSTEMS AND METHODS FOR LOW-LATENCY MEMORY DEVICE

(71) Applicant: Vathys, Inc., Portland, OR (US)

(72) Inventor: Tapabrata Ghosh, Portland, OR (US)

(21) Appl. No.: 16/712,839

(22) Filed: Dec. 12, 2019

(51) Int. Cl. G06F 3/06; G06N 3/04

(52) U.S. Cl. CPC G06F 3/0659; G06N 3/04; G06F 3/068; G06F 3/0611

(57) ABSTRACT

Disclosed are systems and methods for a memory device combining a low-speed, high-density memory architecture with a high-speed, low-density memory architecture, for a low-latency, high-bandwidth memory device that can be used as the memory architecture of an artificial intelligence accelerator. In one embodiment, a workload analyzer module generates a memory access schedule, which can provide memory access before resultant value of the memory access is consumed in a processor.

### BACKGROUND

### Field of the Invention

This invention relates generally to the field of memory devices, and in particular to memory devices used in integrated artificial intelligence processors.

### Description of the Related Art

Memory devices continue to be significant components in computers. The demands of modern computing have spurred innovation in the field of memory technology. The interest and popularity of Artificial Intelligence (AI) and other modern computing realms, have increased the demand for faster and more dense memory architectures. In some cases, AI accelerators and processors have to process big data and associated data structures. Modern memory devices need to store those data structures and service their associated AI processors. A trend in providing more efficient memory and processing has been to locate the resources of each, closer to one another, in order to cut back on costs associated with the transfer of data from memory to processor resources. Consequently, many modern computing hardware focus on integrating memory and processor resources into single devices or at least otherwise keeping those resources in close physical proximity.

At the same time, emerging memory devices can sometimes provide improved memory density, lower leakage, and nonvolatility and other desirable characteristics, but can still be slower than traditional memory devices. For example, an emerging memory technology, nanotube random-access-memory (NRAM) can provide high density, nonvolatility, low leakage and lower power consumption, but it is slower than conventional memories. The high-latency of NRAM, and similar devices, hinders their adoption into on-chip, or integrated processor/memory devices because those integrated devices demand fast memories that can service their coupled fast processors. On the other hand, the high density, non-volatility and improved power consumption of new memory devices, such as NRAM, make them attractive candidates for modern computing tasks, such as AI processing, where large amounts of data need to be stored and processed. Consequently, there is a need for devices and techniques that can use NRAM, and similar devices, in a modern AI processor or other integrated processor/memory device, in a manner that their high memory capacity can be provided with improved speed.

### SUMMARY

In one aspect, an integrated processor, memory system is disclosed. The system includes: a primary memory module; a secondary memory module configured to store workload data; a memory controller configured to control access to read and write operations of the secondary memory module, wherein the memory controller is configured to move workload data from the secondary memory module to the primary memory module according to a memory access schedule; a processor coupled to the primary memory module, wherein the processor is configured to load workload data from the primary memory module and process the workload data; and a workload analyzer configured to generate the memory access schedule comprising the read operations from the secondary memory module into the primary memory module, based at least partly, on an analysis of the workload, wherein the read operations according to the memory access schedule conclude before resultant values from the read operations are to be consumed in processing of the workload data.

In one embodiment, the workload analyzer is further configured to: receive a computer code comprising the workload; determine timing and order of memory read operations from the secondary memory module based on control flow of the computer code; and generate the memory access schedule based at least partly on the determined timing and order.

In some embodiments, the system further includes a processor monitor configured to scan upcoming operations of the processor, and the workload analyzer is further configured to determine upcoming read operations from the secondary memory module and update the memory access schedule based at least partly on the determined upcoming read operations of the secondary memory module.

In one embodiment, the processor monitor is further configured to determine a state of execution of the workload and generating the memory access schedule further comprises the workload analyzer determining upcoming instructions and/or data by parsing the computer code in batches, determining upcoming memory accesses from the secondary memory module and updating the memory access schedule with the determined memory accesses.

In some embodiments, the sizes of the batches are dynamically modified based at least partly on availability of the processor and/or the primary memory module.

In another embodiment, the workload comprises a neural network and the memory access schedule follows the computational graph of the neural network.

In some embodiments, the memory access schedule is further determined based at least partly on one or more of access latency of the secondary memory module, access latency of the primary memory module, and the processing latency of the processor.

In some embodiments, the secondary memory module comprises one or more of NRAM, MRAM, FRAM or a combination thereof.

In one embodiment, the workload comprises one or more of a program instruction or a set of program instructions, one or a set of field-programmable-gate-array (FPGA) nodes, one or a set of dataflow machine nodes, and one or a set of CGRA nodes.

In another embodiment, the system further includes a plurality of processors and primary memory modules, a plurality of secondary memory modules and wherein the processors, primary memory modules and the secondary memory modules are arranged in one or more of a single die/substrate, wafer-scale-integrated (WSI) devices, three-dimensional (3D) integrated chips, and two-dimensional chips stacked vertically, or a combination thereof.

In another aspect, a method disclosed. The method includes: storing workload data on a secondary memory module; reading the workload data from the secondary memory module into a primary memory module coupled to a processor; loading the workload data from the primary memory module to the processor; processing the workload data in the processor; generating a memory access schedule of the read operations from the secondary memory module into the primary memory module, based at least partly on an analysis of the workload, wherein the read operations according to the memory access schedule occur before resultant values of the read operations are to be consumed in the processing of the workload data.

In some embodiments, generating the memory access schedule comprises: receiving a computer code comprising the workload; determining timing and order of memory read operations from the secondary memory module into the primary memory module based on control flow of the computer code; and generating the memory access schedule based at least partly on the determined timing and order.

In one embodiment, the method further includes: monitoring the processor by scanning upcoming operations of the processor; determining upcoming read operations from the secondary memory module; and updating the memory access schedule based at least partly on the determined upcoming read operations of the secondary memory module.

In another embodiment, the method further includes: determining a state of execution of the workload; determining upcoming instructions and/or data by parsing the computer code in batches; determining upcoming memory accesses from the secondary memory module; and updating the memory access schedule with the determined memory accesses.

In one embodiment, the sizes of batches are dynamically modified based at least partly on availability of the processor and/or the primary memory module.

In some embodiments, the workload comprises a neural network and the memory access schedule follows the computational graph of the neural network.

In one embodiment, the memory access schedule is further determined based at least partly on one or more of access latency of the secondary memory module, access latency of the primary memory module, and the processing latency of the processor.

In another embodiment, the secondary memory module comprises one or more of NRAM, MRAM, FRAM or a combination thereof.

In some embodiments, the workload comprises one or more of a program instruction or a set of program instructions, one or a set of field-programmable-gate-array (FPGA) nodes, one or a set of dataflow machine nodes, and one or a set of CGRA nodes.

In some embodiments, the method further includes providing a plurality of processors and primary memory modules, a plurality of secondary memory modules and wherein the processors, primary memory modules and the secondary memory modules are arranged in one or more of a single die/substrate, wafer-scale-integrated (WSI) devices, three-dimensional (3D) integrated chips, and two-dimensional chips stacked vertically, or a combination thereof.

### BRIEF DESCRIPTION OF THE DRAWINGS

These drawings and the associated description herein are provided to illustrate specific embodiments of the invention and are not intended to be limiting.

FIG. 1 illustrates a diagram of an integrated processor/memory system, where low-speed, high-density and low-density, high-speed memory devices along with processors are used in an integrated system.

FIG. 2 illustrates another diagram of the processor/memory system of the embodiment of FIG. 1 and its components and operations.

FIG. 3A illustrates a diagram of execution and/or access of program instructions and data, where a fixed lookahead batch size is used to generate a memory access schedule.

FIG. 3B illustrates a diagram of execution and/or access of program instructions and data, where a variable (or dynamically-determined) lookahead batch size is used to generate a memory access schedule.

FIG. 4 illustrates a diagram of the operations of the processor/memory system of FIGS. 1 and 2 in the context of an artificial intelligence workload.

FIG. 5 illustrates a method of operating an integrated processor/memory device according to an embodiment.

### DETAILED DESCRIPTION

The following detailed description of certain embodiments presents various descriptions of specific embodiments of the invention. However, the invention can be embodied in a multitude of different ways as defined and covered by the claims. In this description, reference is made to the drawings where like reference numerals may indicate identical or functionally similar elements.

Unless defined otherwise, all terms used herein have the same meaning as are commonly understood by one of skill in the art to which this invention belongs. All patents, patent applications and publications referred to throughout the disclosure herein are incorporated by reference in their entirety. In the event that there is a plurality of definitions for a term herein, those in this section prevail. When the terms “one”, “a” or “an” are used in the disclosure, they mean “at least one” or “one or more”, unless otherwise indicated.

Modern computing tasks can be more efficiently performed using integrated or highly integrated systems where processing resources and memory resources are integrated in the same system and are in close physical proximity. Integrated systems use fewer interconnects and have better power consumption and lower latency compared to unintegrated systems. Integrated processor/memory systems can also more efficiently perform artificial intelligence (AI) processing. In many cases, AI processing includes moving voluminous amounts of data, program instructions or data structures between memory resources and one or more processing resources. Consequently, having on-chip or integrated processor/memory systems can speed up AI processing.

Traditional memory devices such as static random-access-memory (SRAM) or dynamic random-access-memory (DRAM) have been used in integrated systems and in AI processing systems, such as AI accelerators. However, emerging memory technologies, such as nanotube random-access-memory (NRAM), magnetic random-access-memory (MRAM) and ferromagnetic random-access-memory (FRAM) offer advantages that may not be achievable using only traditional memory structures. For example, NRAM can offer a high-density, nonvolatile memory device with low leakage and low power consumption. On the other hand, emerging memory devices can be slower than traditional memory devices in some cases. For example, NRAM write speed can be approximately 5 nanoseconds (ns), while SRAM can have write speeds as fast as approximately 100 picoseconds (ps). Therefore, a combined or integrated memory device, which can effectively integrate high-speed memory devices and high-density (albeit maybe low-speed) memory devices can offer greater performance gains in processors employing such an integrated memory device.

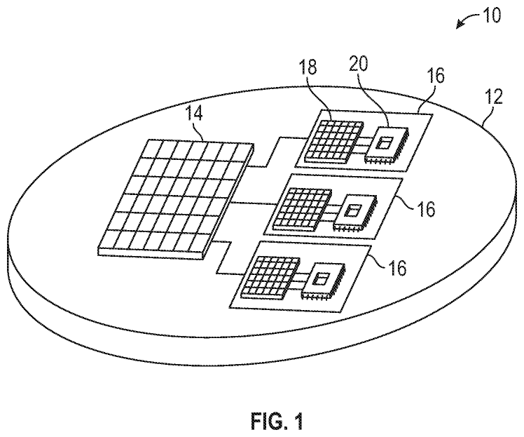

FIG. 1 illustrates a diagram of an integrated processor/memory system 10, where low-speed, high-density and low-density, high-speed memory devices along with processors are used in an integrated system. The integrated processor/memory system 10 can be a variety of integrated systems. For example, the processor/memory system 10 can be built using single die/substrate, wafer-scale-integrated (WSI) devices, three-dimensional (3D) integrated chips, two-dimensional chips stacked vertically, assembled chips (smaller chips connected via interconnects or communication links such as wired or wireless links), chips connected using interposer systems, chips connected using capacitive or inductive coupling. Other examples of integrated processor/memory systems can be built using Intel® embedded multi-die interconnect bridge (EMIB) or University of California at Los Angeles (UCLA) silicon interconnect fabric. For ease of description, the processor/memory system 10 is illustrated in a two-dimensional arrangement; however, the described technology is applicable to any integrated processor/memory system, including three-dimensional structures or structures built with technologies described above.

The processor/memory system 10 includes a substrate 12 (e.g., a crystalline-silicon substrate), a low-speed, but high-density memory module 14 and a plurality of processor/memory pairs 16. The low-speed memory module 14 can be an auxiliary or a secondary memory module and can be a variety of memory devices, such as flash memory, NRAM, MRAM, FRAM and others. The processor/memory pairs 16 can include a fast memory module 18 and a processor core 20. The fast-memory module 18 can be a primary memory module upon which the processor cores 20 can rely for providing their processing functionality. The fast-memory module 18 can include memory devices, such as SRAM and/or DRAM. The low-speed memory module 14 may be “slow” in comparison to memory modules 18 due to use of slower memory cells or by virtue of its higher density or longer distance to processor cores 20 or other characteristics of its memory technology. The processor cores 20 can include a variety of circuits configurable to perform computing. Example processor cores 20 can include, central processing units (CPUs), graphics processing units (GPUs), arithmetic logic units (ALUs), functional units (FUs), coarse-grained reconfigurable architecture (CGRA) processors, registers, caches, buffers, or any other circuits or circuit combinations configurable to process a computing workload. For ease of illustration, the low-speed memory module 14 and the processor/memory pairs 16 are shown as separate components. However, the described embodiments are not so limited. In some embodiments, the low-speed memory module 14 and the processor/memory pairs 16 can be integrated on one die or as part of a wafer-scale-integrated circuits, or as an integrated component of a three-dimensional integrated circuit.

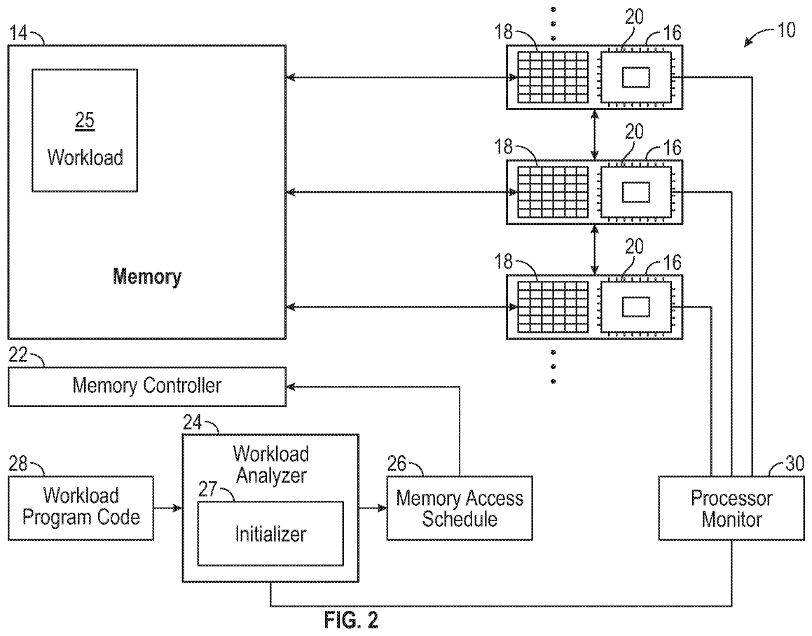

FIG. 2 illustrates another diagram of the processor/memory system 10 and its components and operations. The low-speed, or secondary memory module 14 can be serviced and/or controlled with a memory controller 22, which can maintain a mapping of memory contents of the memory module 14 and the physical memory addresses of the content of the memory module 14 and control read/write operations to and from the secondary memory module 14. NRAM cells work as a memory device because a nanotube fabric in the cell can switch resistance (via a nano electromechanical motion) when in the presence of an electrical field. The nanotube fabric provides memory functionality by retaining its previous state when the applied field is removed.

In one embodiment, the memory module 14 can be an NRAM array comprising various layers, for example, a layer of an addressable memory array transistors and interconnects, such as access transistors, diodes, bit lines, word lines, or other components to access and/or address a memory cell within the memory module 14. The memory module 14 can include a layer of nanotubes deposited on an addressable memory array. The memory module 14 can use a variety of memory architecture, such as a crossbar-type array, a transistor and an NRAM memory cell (“1T1R”) architecture or a combination of the two. A workload 25 can be stored in the memory module 14 having been moved there from an external long-term storage drive (e.g., a hard drive, flash drive, or other long-term storage medium) and/or from a network storage place.

The processor/memory system 10 can include a workload analyzer 24, which can generate a memory access schedule 26. The memory controller 22 can use the memory access schedule 26 to move workload data from the memory module 14 to one or more high-speed memory modules 18 for processing in the one or more processor cores 20. In some embodiments, the memory access schedule 26 can be generated in a manner to reduce or minimize speculative fetching, in order to reduce or minimize energy waste associated with unnecessary fetching of data from the memory module 14 to the memory modules 18. In this manner, resultant values of memory read operations according to the memory access schedule 26 can be available to the one or more processor cores 20 before those resultant values are to be consumed in the processing of the workload 25 in the one or more processor cores 20.

By moving workload data from a low-speed memory module 14 to one or more high-speed memory modules 18 before the workload data is to be processed in the processor cores 20, processor idle time can be reduced, hardware utilization rates can increase and overall efficiency of the integrated processor/memory system 10 can be improved, as the processor cores 20 have more efficient access to the incoming data. Such efficiencies allow for hardware that can be used with modern computing tasks, where processing of large volumes of data is desirable. For example, the integrated processor/memory system 10 can be used as an AI accelerator.

In one embodiment, the workload analyzer 24 can include an initializer module 27, which can run one or more test or initialization scripts on the memory module 14, memory modules 18 and/or processor cores 20 to extract system parameters that can be used in generating the memory access schedule 26. Example parameters that can be extracted include access latency to and from the memory module 14, relative to locations of various memory cells or locations of a plurality of cell regions within the memory module 14, memory latency of the memory modules 18 and processing latency in the one or more processor cores 20. In other embodiments, such parameters can be predetermined and prestored on a read-only-memory (ROM) or other nonvolatile storage medium in the workload analyzer 24 and later be used in generating memory access schedules 26 for various workloads 25.

Workload data, which can be loaded from a low-speed memory module 14 to one or more high-speed memory modules 18, before their processing or execution can include a variety of data, such as a program instruction or a set of program instructions, one or a set of field-programmable-gate-array (FPGA) nodes, one or a set of dataflow machine nodes, one or a set of CGRA nodes, various data structures, such as vectors, matrices, arrays or tensors, scalar variables, and any other data that can be present in a computer program or can be used in execution of a computer program.

Static Memory Access Schedule

In one embodiment, the workload analyzer 24 can analyze a computing workload 25 and generate an efficient memory access schedule 26 before execution of the workload 25. For example, the workload analyzer 24 can parse a program code 28 associated with or underlying the workload 25 and generate a timing and order of loading workload data from the memory module 14 to one or more memory modules 18. The program code 18 can be in a variety of high-level and/or low-level formats. Example formats for program code 28 can include, hardware description language (HDL), register-transfer-level (RTL), Verilog, and others.

Some program codes 28 underlying a workload 25 can have limited or fixed control flow, where instructions and/or memory values that are to be processed, can be determined from parsing the program code 28 before their execution in the processor cores 20. An example of a limited control flow program code 28 can be found in artificial intelligence or machine learning workloads. The control flow of such programs can follow the computational graph of a neural network. For example, when processing an inference or forward propagation of some neural networks, the program control flow can include sequentially processing each layer of a neural network until the network outputs are generated. Another example, includes backpropagating a neural network, where each layer of the neural network is processed sequentially in reverse order until gradient updates are generated and the neural network weights are updated. Additionally, for some neural network programs, the number of forward and backward passes through the neural network can be determined prior to processing of the neural network. In such programs, the upcoming memory accesses can be determined before execution of the workload and a memory access schedule 26 can be generated in a manner that follows the computational graph or the order of the execution of the neural network. In this manner, the memory values and/or instructions that are to be executed can be made available in one or more high-speed and fast-access memory modules 18, so the one or more processor cores 20 can access those memory values and/or instructions, and bypass the latency of the memory module 14.

Other analysis of the workload 25 and/or the program code 28 can inform the memory access schedule 26. For example, the sizes of the data structures in the workload 25 and their memory locations in relation to the pre-determined latency of the memory module 14 in addition to the control flow of the program code 28 can determine a start time of read operations for those data structures.

Dynamic Memory Access Schedule

The memory access schedule 26 can also be generated or updated dynamically as a workload 25 is being processed in the one or more processor cores 20. Some upcoming memory accesses related to the processing of the workload 25 can be revealed during the processing of the workload 25 and as the processing of the workload 25 progresses. For example, during processing of a workload 25 conditional branches can be resolved, and memory accesses associated with an executed branch and its subsequent subroutines can be dynamically added to the memory access schedule 26.

In addition, a dynamically-determined memory access schedule 26 can be generated by looking ahead at upcoming program instructions and their associated memory accesses, determining the memory accesses that are to be performed from the low-speed memory module 14 and performing those memory accesses before they are to be consumed by the one or more processor cores 20. In one embodiment, a processor monitor 30 can monitor and report the state of execution of a workload 25 to the workload analyzer 24. The program code 28 along with the current state of execution data can reveal upcoming program instructions and memory accesses. In this manner, the workload analyzer 24 can determine the upcoming memory accesses that are to be performed from the memory module 14 and can update the memory access schedule 26 to schedule those memory accesses before their resultant values are to be consumed in the processor cores 20.

Fixed or Variable Lookahead Batch Sizes

Memory access schedule 26 can be generated by looking ahead at upcoming program instructions and/or data in batches. A predetermined or a dynamically-determined number of upcoming program instructions and/or data equal to a batch size can be parsed and associated memory accesses can be determined. For memory accesses that are to initiate from the low-speed memory module 14, the memory access schedule 26 can be updated to perform those memory accesses before the resultant memory accesses are to be consumed in the one or more processor cores 20.

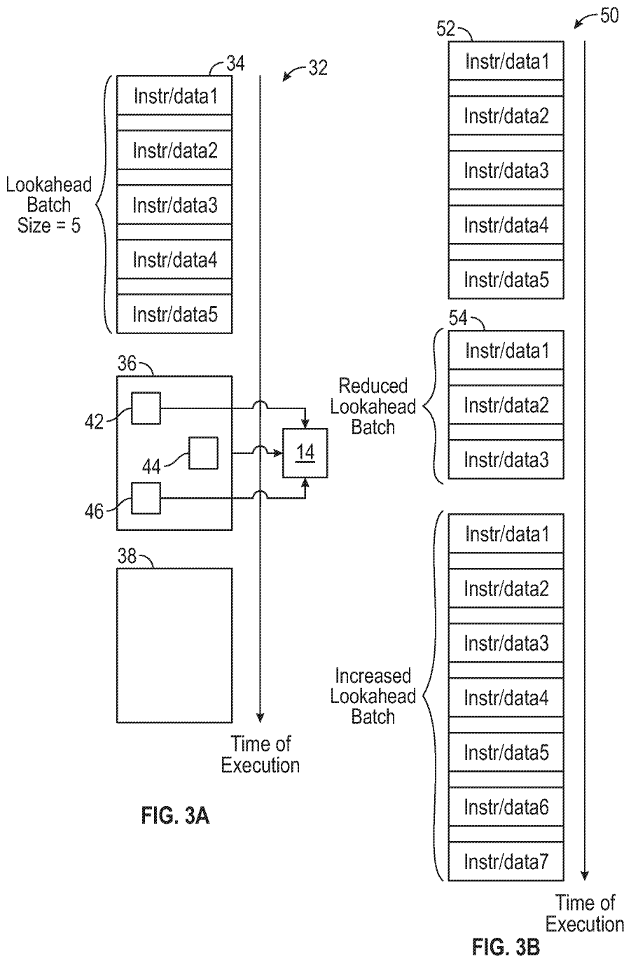

FIG. 3A illustrates a diagram 32 of execution and/or access of program instructions and data, where a fixed lookahead batch size is used to generate the memory access schedule 26. Workload analyzer 24 can obtain, from processor monitor 30, the current location of execution of the program code 28 and look ahead at upcoming program instructions and/or program data in fixed batch sizes. For illustration purposes, a fixed lookahead batch size of “5” is shown. An upcoming program instruction/data batch 34 is parsed and no instruction and/or data with a memory access from the memory module 14 is detected. Next, the upcoming program instruction batch 36 is parsed and three instances of memory accesses, 42, 44, and 46 to the memory module 14 is detected, therein. The memory access schedule 26 can be updated with the memory accesses 42, 44 and 46 to schedule their retrieval (loading from memory module 14 to one or more memory modules 18) before the resultant value of those memory accesses are to be consumed in the one or more processor cores 20.

FIG. 3B illustrates a diagram 50 of execution and/or access of program instructions and data, where a variable (or dynamically-determined) lookahead batch size is used to generate the memory access schedule 26. Workload analyzer 24 can obtain from processor monitor 30 the current location of execution of the program code 28 and look ahead at upcoming program instructions and/or program data starting with a default lookahead batch size of for example “5”. The processor monitor 30 can indicate a lower availability of the memory modules 18 and/or the processor cores 20, in which case, the workload analyzer 24 can use a reduced size lookahead batch to temporarily reduce the amounts of data moved from the memory module 14 to the now-busy memory modules 18 and processor cores 20. The lookahead batch size can revert back to its default value when the processor monitor 30 can indicate better availability of the processor cores 20 and their associated memories.

Alternatively, the workload analyzer 24 can receive an input from the processor monitor 30 indicating an increased availability of the one or more processor cores 20 and/or the memory modules 18, where more instructions/data from the memory module 14 can be uploaded to the memory modules 18. The workload analyzer 24 can increase the lookahead batch size to allow more upcoming instruction/data to be loaded form memory module 14 to the one or more memory modules 18 at a faster rate.

The illustrated lookahead batch sizes are provided as examples and smaller or larger lookahead batch sizes can be used, depending on the implementation of the processor/memory system 10 and the nature of the workload 25. For some workloads 25, the lookahead batch size can be small if the instructions/data in the batch size contain memory accesses to voluminous data structures in the memory module 14, so a few instructions/data can entail many updates to the memory access schedule 26. On the other hand, the lookahead batch size may be large if a program code 28 or a segment therein contains few memory accesses to the memory module 14. Additionally, conditional instructions/data in a lookahead batch can be ignored if the branches of the conditional contain no request to access the memory module 14. For conditional branches, where one or more branches contain memory accesses to the memory module 14, the workload analyzer 24 can temporarily halt updating the memory access schedule 26 until the conditional statement is resolved.

### Example Operations in an AI Workload

The described embodiments can be applied in the context of AI accelerators configured to process AI workloads. AI applications, such as language processing, demand substantial amounts of memory (e.g., in the order of hundreds of gigabytes for today's applications). At the same time, the amount of on-chip fast memory (such as SRAM, DRAM, etc. is only in the order of hundreds of megabytes) and lags behind the demand of modern AI applications. In the context of AI accelerators, substantial benefit in the performance of an accelerator can be achieved if the amount (capacity) of on-chip memory of the accelerator matches or exceeds the amount of AI data the accelerator is to process. Furthermore, increased memory bandwidth can also substantially improve the performance of AI accelerators. New memory architectures, such as NRAM and the like, can offer substantially higher capacity and bandwidth, but their latency can, nonetheless degrade the performance of the accelerators, which integrate them as on-chip memory. For example, a memory latency of more than 5 nanoseconds (ns) can lead to degradation of performance of an AI accelerator in processing AI workloads. The described embodiments, provide systems and methods for circumventing and masking the inherent latency of memory devices, such as NRAM, so they can be effectively used as on-chip integrated memory in AI accelerators and other processors. The high bandwidth and high capacity of such memory devices can enable more performant AI accelerators.

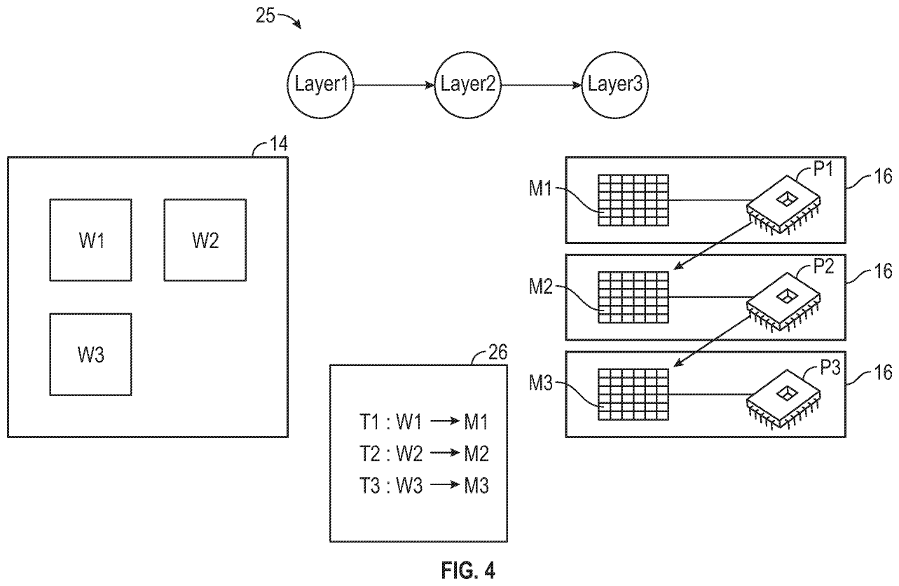

FIG. 4 illustrates a diagram of the operations of the processor/memory system 10 in the context of an artificial intelligence workload. In the example shown, the workload 25 can be a neural network having three layers. The weights matrix W1 is associated with layer “1”, the weights matrix W2 is associated with layer “2” and the weights matrix W3 is associated with layer “3”. Weights matrices W1, W2 and W3 are stored in the memory module 14. Three processor/memory pairs 16 are shown, containing processor cores P1, P2, P3 and memory modules M1, M2, and M3, respectively.

The workload analyzer 24 can receive the program code 28 corresponding to the workload 25 and parse the instructions/memory accesses, therein. In the case of artificial intelligence workloads, a computational graph can be extracted, where the order of execution of layers and operations of the AI workload can be used to generate a static or dynamic memory access schedule 26 before the execution of the AI workload 25 begins or as the execution of the AI workload 25 is underway. For example, the memory access schedule 26 can include a timeline of upcoming memory accesses in chronological order, according to which the memory controller 22 moves workload 25 data from the memory module 14 to the memory modules M1, M2 or M3. In some embodiments, the timeline can be associated with one or more CPU clock signals. An example timeline can be at time T1, the data associated with processing of layer “1” of the neural network is moved from the memory module 14 to the memory module M1. The time T1 occurs at a time before the resultant value of the memory access (W1) is to be consumed by a processor core 20, for example, the processor core P1. Additional entries in the memory access schedule 26 can include: at time T2, weights matrix W2 data is to be loaded to the memory module M2, and at time T3, the weights matrix W3 is to be loaded to the memory module M3. The times T2 and T3 occur before the resultant values of their associated memory accesses (W2 and W3) are to be consumed in a processor core.

The weights matrices W1-W3 are provided as example workload data that may be present in the memory module 14 and other workload data, such as program instructions, neural network biases, training sets, and any other AI related workload data may be present in the memory module 14. In some embodiments, the volume of a weights matrix may be more than the capacity of a memory module M1 and the weights matrix may be loaded and processed in compartments or loaded into more than one memory module.

An access latency AL of the memory module 14 and/or processing latency PL of the processor cores 20 can be used in determining the timelines in the memory access schedule 26. The values of AL and PL can be determined by the operation of the initializer module 27, as described above or they can be predetermined and stored in an internal memory of the workload analyzer 24. One method of generating the time schedules of the memory access schedule 26 can be according to Equation 1, where Tn is the memory access initiation time for a weights matrix Wn or a portion thereof, tₙ is the upcoming execution time for processing of the weights matrix Wn or portion thereof, and a and b are variables, which can be adjusted to modify how soon Wn is loaded relative to its upcoming execution time.

$$for {W}_{n} , {T}_{n} = \{ \begin{matrix}0 , & {t}_{n} - aPL - bAL < 0 \\ {t}_{n} - aPL - bAL , & {t}_{n} - aPL - bAL \geq 0\end{matrix} \qquad Eq . 1$$

Using larger values of a and b can lead to loading the workload data sooner before its execution. When larger values of a and b are used, correspondingly larger memory modules M1-M3 can be used to store the preloaded data. On the other hand, smaller values of a and b can be used to preload from the memory module 14 closer to execution time, thereby smaller memory modules M1-M3 can be used. In some embodiments, average or worse-case delays can be used for AL and PL values or they can be derived with more granularity for example, based on the region of the memory module 14 from which they are accessed. In that case, Equation 1 can be modified to use corresponding AL and PL values based on the region of the memory from which the weights matrix Wn is accessed and based on the processor core 20 which is going to process the weights matrix Wn. In other embodiments, Equation 1 can be modified to include an access latency of the memory modules M1, M2, M3. The weights matrices Wn are provided as example workload data, which maybe preloaded. However, other workload related data or a portion of weights matrices can be used.

In some embodiments, the described systems and methods can be combined with systems and methods described in U.S. patent application Ser. No. ______, filed on ______, entitled, “SPATIAL MODEL OF COMPUTATION FOR EFFICIENT DEEP LEARNING,” (Attorney Docket No. 2744-US-12-0020-01), the contents of which is hereby incorporated herein in its entirety and should be considered part of this disclosure. For example, during an inference or forward processing of the workload 25, weights matrix W1 is loaded to memory module M1 at time T1. Weights matrix W2 is loaded to memory module M2, at time T2, and the weight matrix W3 is loaded to memory module M3, at time T3, where T1, T2 and T3 are determined according to the embodiments described above. Accordingly, layer “1” of the workload 25 is processed in processor core P1 and associated data is loaded from memory module M1 to processor core P1. The output of the processing of layer “1” is stored in memory module M2. Layer “2” and its associated data are loaded from memory module M2 to the processor core P2 and the output of the processing of layer “2” is stored in memory module M3. During backpropagation, the processing described above is reversed. After a predetermined number of forward and backward passes between processor cores P1-P3, the output of the workload 25 is generated. The processor/memory pairs (P1, M1), (P2, M2) and (P3, M3) are in close proximity and follow the same order that the computational graph of workload 25 indicates. The timelines of the memory access schedule 26 moves weights matrices and other workload data (such as biases) from low-speed memory module 14 to the high-speed memory modules M1, M2, M3, before the corresponding processor cores P1, P2 and P3 are to process them. In other words, weights and workload data can be loaded to processor/memory pairs 16, spatially and temporally following the computational graph of the workload 25.

When fewer processor/memory pairs 16, relative to the number of layers of the workload 25, are available, the processor/memory pairs 16 can be reused to continue processing the layers in a manner that follows the spatial and temporal order of the computational graph of the workload 25. The memory access schedule 26 can include timelines corresponding to additional weights matrices associated with additional layers. For example, while not shown, if the workload 25 included three additional layers, and weights matrices W4, W5 and W6, corresponding to each layer, the memory access schedule 26 can include additional timeline entries, such as, at time T4 load W4 from memory module 14 into memory module M1, at time T5, load W5 from memory module 14 into memory module M2 and at time T6, load W6 from memory module 14 into memory module M3.

In other embodiments, the contents of weights matrices Wn may be more than the capacity of a memory module 18. In those scenarios, the data associated with the workload 25 may need to be processed in compartments or batches. The load time corresponding to weights matrices can include sub-load times corresponding to the different compartments of data. The execution of data compartments can also occur in parallel over two or more processor/memory pairs 16 or occur sequentially over a single processor/memory pair 16.

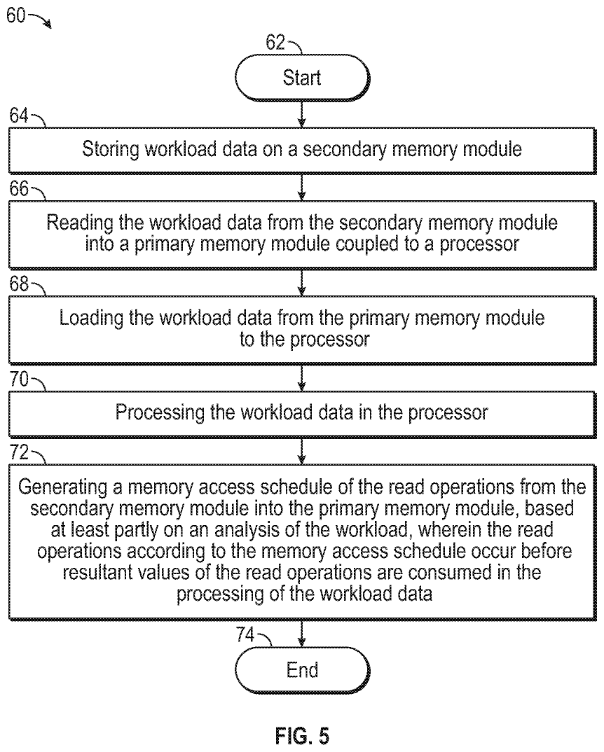

FIG. 5 illustrates a method 60 of operating an integrated processor/memory device. The method starts at the step 62. The method moves to the step 64 by storing workload data on a secondary memory module. The method then moves to the step 66 by reading the workload data from the secondary memory module into a primary memory module coupled to a processor. The method then moves to the step 68 by loading the workload data from the primary memory module to the processor. The method then moves to the step 70 by processing the workload data in the processor. The method then moves to the step 72 by generating a memory access schedule of the read operations from the secondary memory module into the primary memory module, based at least partly on an analysis of the workload, wherein the read operations according to the memory access schedule occur before resultant values of the read operations are consumed in the processing of the workload data. The method ends at the step 74.

What is claimed is:

1. An integrated processor, memory system comprising:
a primary memory module;
a secondary memory module configured to store workload data;
a memory controller configured to control access to read and write operations of the secondary memory module, wherein the memory controller is configured to move workload data from the secondary memory module to the primary memory module according to a memory access schedule;
a processor coupled to the primary memory module, wherein the processor is configured to load workload data from the primary memory module and process the workload data; and
a workload analyzer configured to generate the memory access schedule comprising the read operations from the secondary memory module into the primary memory module, based at least partly, on an analysis of the workload, wherein the read operations according to the memory access schedule conclude before resultant values from the read operations are to be consumed in processing of the workload data.

2. The system of claim 1, wherein the workload analyzer is further configured to:
receive a computer code comprising the workload;
determine timing and order of memory read operations from the secondary memory module based on control flow of the computer code; and
generate the memory access schedule based at least partly on the determined timing and order.

3. The system of claim 1 further comprising a processor monitor configured to scan upcoming operations of the processor, and the workload analyzer is further configured to determine upcoming read operations from the secondary memory module and update the memory access schedule based at least partly on the determined upcoming read operations of the secondary memory module.

4. The system of claim 3, wherein the processor monitor is further configured to determine a state of execution of the workload and generating the memory access schedule further comprises the workload analyzer determining upcoming instructions and/or data by parsing the computer code in batches, determining upcoming memory accesses from the secondary memory module and updating the memory access schedule with the determined memory accesses.

5. The system of claim 4, wherein sizes of the batches are dynamically modified based at least partly on availability of the processor and/or the primary memory module.

6. The system of claim 1, wherein the workload comprises a neural network and the memory access schedule follows the computational graph of the neural network.

7. The system of claim 1, wherein the memory access schedule is further determined based at least partly on one or more of access latency of the secondary memory module, access latency of the primary memory module, and the processing latency of the processor.

8. The system of claim 1, wherein the secondary memory module comprises one or more of NRAM, MRAM, FRAM or a combination thereof.

9. The system of claim 1, wherein the workload comprises one or more of a program instruction or a set of program instructions, one or a set of field-programmable-gate-array (FPGA) nodes, one or a set of dataflow machine nodes, and one or a set of CGRA nodes.

10. The system of claim 1 further comprising a plurality of processors and primary memory modules, a plurality of secondary memory modules and wherein the processors, primary memory modules and the secondary memory modules are arranged in one or more of a single die/substrate, wafer-scale-integrated (WSI) devices, three-dimensional (3D) integrated chips, and two-dimensional chips stacked vertically, or a combination thereof.

11. A method comprising:
storing workload data on a secondary memory module;
reading the workload data from the secondary memory module into a primary memory module coupled to a processor;
loading the workload data from the primary memory module to the processor;
processing the workload data in the processor;
generating a memory access schedule of the read operations from the secondary memory module into the primary memory module, based at least partly on an analysis of the workload, wherein the read operations according to the memory access schedule occur before resultant values of the read operations are to be consumed in the processing of the workload data.

12. The method of claim 11, wherein generating the memory access schedule comprises:
receiving a computer code comprising the workload;
determining timing and order of memory read operations from the secondary memory module into the primary memory module based on control flow of the computer code; and
generating the memory access schedule based at least partly on the determined timing and order.

13. The method of claim 11 further comprising:
monitoring the processor by scanning upcoming operations of the processor;
determining upcoming read operations from the secondary memory module; and
updating the memory access schedule based at least partly on the determined upcoming read operations of the secondary memory module.

14. The method of claim 13, further comprising
determining a state of execution of the workload;
determining upcoming instructions and/or data by parsing the computer code in batches;
determining upcoming memory accesses from the secondary memory module; and
updating the memory access schedule with the determined memory accesses.

15. The method of claim 14, wherein sizes of batches are dynamically modified based at least partly on availability of the processor and/or the primary memory module.

16. The method of claim 11, wherein the workload comprises a neural network and the memory access schedule follows the computational graph of the neural network.

17. The method of claim 11, wherein the memory access schedule is further determined based at least partly on one or more of access latency of the secondary memory module, access latency of the primary memory module, and the processing latency of the processor.

18. The method of claim 11, wherein the secondary memory module comprises one or more of NRAM, MRAM, FRAM or a combination thereof.

19. The method of claim 11, wherein the workload comprises one or more of a program instruction or a set of program instructions, one or a set of field-programmable-gate-array (FPGA) nodes, one or a set of dataflow machine nodes, and one or a set of CGRA nodes.

20. The method of claim 11 further comprising: providing a plurality of processors and primary memory modules, a plurality of secondary memory modules, and wherein the processors, primary memory modules and the secondary memory modules are arranged in one or more of a single die/substrate, wafer-scale-integrated (WSI) devices, three-dimensional (3D) integrated chips, and two-dimensional chips stacked vertically, or a combination thereof.
